(19) United States
(12) Patent Application Publication
(10) Pub. No.: US 2006/0274651 A1
(43) Pub. Date: Dec. 7, 2006

(54) Method and apparatus for dynamically establishing links between communication channels

(76) Inventors: David Menard, Brossard (CA); Eric Reiher, Longueuil (CA)

Correspondence Address: Ralph A. Dowell of DOWELL & DOWELL P.C., 2111 Eisenhower Ave, Suite 406, Alexandria, VA, 22314, US

(21) Appl. No.: 11/145,957

(22) Filed: Jun. 7, 2005

(51) Int. Cl. H04L 12/26

(52) U.S. Cl. 370/229

(57) ABSTRACT

A method and device for establishing links between communication channels is described. Real link information conveying a set of real links between communication channels in a set of communication channels is provided. The real link information is processed to derive link control data conveying the set of real links and virtual link information. A control signal is then released for causing a communication apparatus to establish or remove links between communications channels in the set of communication channels, the control signal being derived at least in part on the basis of the link control data.

### FIELD OF THE INVENTION

The present invention relates generally to communication systems and, more particularly, to a method and apparatus for establishing links between communication channels.

### BACKGROUND

Broadly stated, a bridge is a device that facilitates interaction between a set of communication channels. In a typical interaction, the bridge receives a plurality of media signals from multiple communication channels associated to respective media sources. The bridge processes the received media signals and effects the required mixing and transmissions on the basis of established links between the communication channels. The links between communication channels may be bi-directional or unidirectional. When a communication channel connects to another communication channel using a bi-directional link, both will then be able to “talk to” (transmit) and “hear”(receive) the other. When a communication channel connects to another communication channel using a unidirectional link, only the destination will “hear” (receive) what the source says.

In a packet-based communication system, the media signals are in the form of packets. Typically, in such systems, the bridge receives the media data packets and forms mixed, composite media signals consisting of selected media signals. The bridge then encodes the media signals and forwards them over the appropriate communication channels on the basis of the established links. Typically, the bridge is controlled by a bridge controller that transmits signals conveying which communication links are to be connected through the bridge.

A deficiency in commonly used bridge controllers is that, in order for multiple communication channels to be linked to one another, a conference architecture must be set up in which the communication channels must explicitly request to be linked to the conference. As such, conventional conference architectures make use of a centralized topology where all communication channels are connected through a central point either in bidirectional or unidirectional mode. Take for example three (3) communication channels, say communication channels A, B and C. Suppose communication channel A and communication channel B are linked to each other through a conventional bridge so that communication channel A can hear and talk to communication channel B and vice versa. Now suppose communication channel A and communication channel C establish a connection to one another so that communication channel A can hear and talk to communication channel C and communication channel C can hear and talk to communication channel A. Logically, communication channel B should be able to hear and talk to communication channel C. However, in existing communication systems, communication channel B will not be connected to communication channel C and will not be able to exchange information with communication channel C. In order for a connection to be established between communication channel C and B, communication channel C is typically required to explicitly join the conference between communication channel A and communication channel B.

Moreover, existing systems do not provide mechanisms for suitably interconnecting various audio sources such as sound cards, cellular lines, telephone lines and VoIP line amongst others.

Against the background described above, it appears that there is a need in the industry to provide a method and apparatus for establishing links between communication channels that alleviates at least in part the deficiencies associated with the prior art.

### SUMMARY

Generally speaking, for the purpose of the present specification, a link between two communication channels may be a real communication link or a virtual communication link. Two channels are linked together through a real communication link when an explicit request was made in connection with either one of the two channels to establish a link between the two channels. Two channels are linked together through a virtual communication link when, in the absence of an explicit request made in connection with either one of the two channels to establish a link between the two channels, the link between the two channels is created by virtue of the existence of one or more links between other communication channels. The request to establish a real link between two communication channel may originate from either one of the communication channels or from an third party entity.

An example will better illustrate the distinction between a real communication link and a virtual communication link. Suppose that, as a result of a first link request, communication channel A and communication channel B are connected to one another over a real link so that communication channel A can hear and talk to communication channel B and vice versa. Suppose that as a result of a second link request, communication channel A and communication channel C are also connected to one another over a real link so that communication channel A can hear and talk to communication channel C and vice versa. By virtue of the real link between communication channel A and communication channel B and of the real link between communication channel A and communication channel C, communication channel B is connected to communication channel C over a virtual link, even though there was no explicit link request for a connection between communication channel B and communication channel C. Hence communication channel B will be able to talk to and to hear communication channel C and, similarly, communication channel C will be able to talk to and to hear communication channel B. In summary we have:
A <-> real link <-> B
A <-> real link <-> C
then
B <-> virtual link <-> C
   where <-> indicates the presence of a bi-directional link.

As such, a virtual communication link is derived between communication channel B and communication channel C. It can be appreciated that if the real link between communication channel A and communication channel B is disabled, then the virtual link between communication channel B and communication channel C will also be disabled.

In accordance with a first broad aspect, the invention provides a method for establishing links between communication channels. The method comprises providing real link information conveying a set of real links between communication channels in a set of communication channels and processing the real link information to derive link control data. The link control data includes the set of real links and virtual link information. The method further comprises releasing a control signal for causing a communication apparatus to establish links between communications channels in the set of communication channels, the control signal being derived at least in part on the basis of the link control data.

Advantageously, by deriving virtual link information on the basis of real link information, a link may be established between two (2) communication channels without the requirement to provide an explicit request for establishing the link between the two (2) communication channels.

In specific implementations, the set of real links may include either unidirectional links, bi-directional links or both bi-directional and unidirectional links.

In specific implementations, the set of virtual links may include either unidirectional links, bi-directional links or both bi-directional and unidirectional links.

In accordance with a specific implementation, the method comprises providing a first data structure including a first set of data elements conveying the set of real links between communication channels in the set of communication channels. The method comprises processing the first data structure to derive a second data structure including a second set of data elements, the second set of data elements conveying the set of real links and at least one virtual link. The second data structure is then processed to derive link control data.

In a specific implementation, the first data structure is a first matrix data structure and the second data structure is a second matrix data structure. In yet another specific implementation, the first matrix data structure and the second matrix data structure are square matrices and the method comprises applying a squaring operation to the first matrix data structure to derive the second matrix data structure. In a non-limiting implementation, the method comprises applying multiple squaring operation to the first matrix data structure to derive the second matrix data structure.

In accordance with a specific implementation, the method comprises modifying the real link information to derive new real link information in response to a signal indicative of a request for establishing a link between a first communication channel and a second communication channel in the set of communication channels. The new real link information conveys the set of real links and a new real link between the first communication channel and the second communication channel. The method also comprises processing the new real link information to derive new link control data and releasing a control signal derived at least in part on the basis of the new link control data.

In accordance with another specific implementation, the method comprises modifying the real link information to derive new real link information in response to a signal indicative of a request for removing a link between a first communication channel and a second communication channel in the set of communication channels. The new real link information conveys the absence of a link between the first communication channel and the second communication channel. The method comprises processing the new real link information to derive new link control data and releasing a control signal derived at least in part on the basis of the new link control data.

In accordance with yet another broad aspect, the invention provides an apparatus suitable for use in establishing links between communication channels in accordance with the above-described method.

In accordance with yet another broad aspect, the invention provides a computer readable storage medium including a program element suitable for execution by a computing apparatus for use in establishing links between communication channels in accordance with the above-described method.

In accordance with yet another broad aspect, the invention provides a communication system suitable for establishing links between communication channels. The communication system includes a plurality of ports, each port being associated to a respective communication channel in a set of communication channels. The system also includes an apparatus and a bridge in communication with the plurality of ports. The apparatus comprises a memory unit for storing real link information conveying a set of real links between communication channels in the set of communication channels. The apparatus also comprises a processing unit in communication with the memory unit, the processing unit being operative for processing the real link information to derive link control data conveying the set of real links and virtual link information. The apparatus also comprises an output for releasing a control signal derived at least in part on the basis of the link control data. The bridge is in communication with the output of the apparatus and is responsive to the control signal for establishing links between the set of communication channels.

In accordance with yet another broad aspect, the invention provides an apparatus suitable for establishing links between communication channels. The apparatus comprises means for storing real link information conveying a set of real links between communication channels in a set of communication channels. The apparatus also comprises processing means for processing the real link information to derive link control data conveying the set of real links and virtual link information. The apparatus also comprises means for releasing a control signal for causing a communication apparatus to establish or remove links between communications channels in the set of communication channels, the control signal being derived at least in part on the basis of the link control data.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of the embodiments of the present invention is provided herein below, by way of example only, with reference to the accompanying drawings, in which:

FIG. 1 is a block diagram of a communication architecture including a communciation system suitable for establishing links between communication channels in accordance with a specific example of implementation of the invention;

FIG. 2 is a flow diagram of a process for deriving a control signal for causing links to be established between communication channels in accordance with a specific example of implementation of the invention;

FIG. 3 is a block diagram of an apparatus for establishing links between communication channels in accordance with a specific example of implementation of the invention and suitable for use in the system shown in FIG. 1;

FIG. 4a shows a data structure for storing information conveying real link information and virtual link information between communication channels in accordance with a specific example of implementation of the invention;

FIGS. 4b and 4c each show the contents of two data structures in two different scenarios when deriving virtual and real link information in accordance with a specific example of implementation of the invention;

FIG. 5 shows a process for deriving a data structure including virtual and real link information in accordance with a specific example of implementation of the invention;

FIG. 6 is a block diagram of an apparatus for implementing an interface module in accordance with a non-limiting example of implementation of the invention and suitable for use in the system shown in FIG. 1.

FIG. 7 is a block diagram of a computing apparatus programmed to derive link control data in accordance with a specific example of implementation of the invention.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

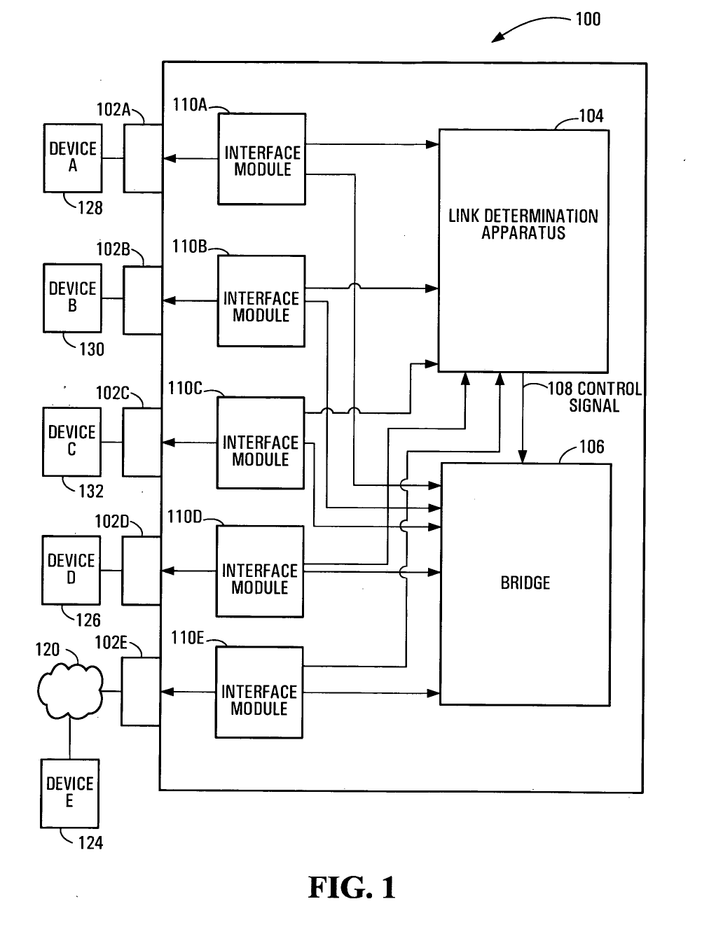

FIG. 1 shows a communications architecture in which a plurality of communication devices 128, 130, 132, 126 and 124 are desirous of entering into communication with each other through communication system 100.

The devices 128, 130, 132, 126 and 124 may be directly connected to communication system 100 or may be connected indirectly to communication system 100 through a network 120, a computing device (not shown in the figure) or through any other suitable intermediate device. In the example depicted in FIG. 1, device 124 is connected to communication system 100 through network 120. In will be appreciated that the direct and indirect connections may be effected through any suitable means, including wire-line connections or wireless connections, without detraction from the spirit of the invention.

The devices 128, 130, 132, 126 and 124 may be any suitable device adapted for either transmitting signals, receiving signals or transmitting and receiving signals. The signals transmitted or received by the devices may be of any suitable format including audio signals, video signals and data signals.

Examples of devices 128, 130, 132, 126 and 124 include, without being limited to, telephony devices such as telephones; PSTN phone line; PBX; VoIP connection or VoIP phones; personal computing devices; a software component running on personal computers; Telco line; cellular line; any suitable audio hardware device; voice device via TTS; sound card; IP Multicast; headsets (headphone); microphone; speakers and personal communication devices. It will become apparent to the reader further to the reading of the present specification, that the various devices 128, 130, 132, 126 and 124 need not all be located in the same type of communication protocol domain. More specifically, it is within the scope of the invention for the devices 128 130 132 126 124 to include packet-based devices (example: VoIP phone) and circuit switched devices (example: phone connection through the PSTN) in a same physical embodiment.

The communication system 100 is adapted for allowing the various devices 128, 130, 132, 126 and 124 to be interconnected in order for information to be exchanged between these devices.

As depicted in FIG. 1, the communication system 100 includes a plurality of ports 102A-E or other suitable I/O interface, a link determination apparatus 104 and a bridge 106. Optionally, the communication system 100 further includes a plurality of interface module 110A-E for providing pre-processing and/or post-processing functionality for the communication channels.

As shown in FIG. 1, each communication device 128, 130, 132, 126 and 124 communicates with the communication system 100 through a respective communication channel and is connected to the bridge through a respective port 102A-E.

The bridge 106 is adapted for allowing the various communication channels associated to the devices 128, 130, 132, 126 and 124 to be interconnected in order for information to be exchanged. The link determination apparatus 104 generates a control signal 108 for causing the bridge 106 to establish links between the communication channels. More specifically, the link determination apparatus 104 receives link request signals and exit signals and updates real link information on the basis of these signals. Link request signals request the creation of a new real link and the exit signals request the removal of an existing real link. The link determination apparatus 104 then processes the real link information to derive link control data conveying real links and virtual links.

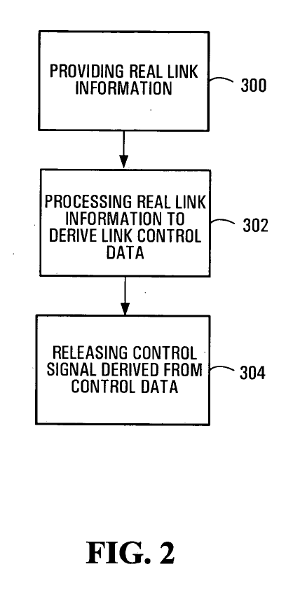

FIG. 2 is a flow diagram describing a process for deriving a control signal 108 as implemented by the link determination apparatus 104 in accordance with a specific example of implementation of the invention. As shown, at step 300, real link information is provided to the link determination apparatus 104 conveying a set of real links between communication channels. At step 302, the real link information is processed to derive link control data including the set of real links and virtual link information. Specific examples of the manner in which the virtual link information is derived by the link determination apparatus 104 will be described later on in the specification. At step 304, a control signal 108 (shown in FIG. 1) is released on the basis of the link control data for causing the bridge 106 (also shown in FIG. 1) to establish links between communications channels in the set of communication channels.

Advantageously, the process implemented by the link determination apparatus 104 allows the bridge 106 to establish real and virtual links between communication channels by inferring the virtual link information from the real link information.

The control signal 108 released by the link determination apparatus 104 conveys the desired state of each of the links between the various communication channels. The bridge 106 receives this control signal 108 and establishes or removes the required link conveyed by the control signal 108. In a specific implementation, the bridge 106 is a packet switched bridge that suitably combines and mixes packets originating from a plurality of communication channels. The specific configuration of the bridge 106 is not critical to the invention and any suitable bridge can be used to provide connectivity between the communication channels on the basis of the control signal 108. More specifically, the assembly of the packet for virtual links or for real links is the same from the perspective of the bridge 106 and therefore any suitable bridge may be used without the need for the bridge to be aware of whether a link is real or virtual. Such packet based bridges are well known and, as such, need not be described further here.

Although the present description the bridge 106 refers to a packet switched bridge, other types of bridges, such as circuit switched bridges, can also be used without detracting from the spirit of the invention provided the suitable interfaces for converting signals are provided.

Link Determination Apparatus 104

As indicated above, the link determination apparatus 104 is adapted for processing real link information to derive a link control signal 108. The link control signal 108 specifies the desired states of the links between the various communication channels and is adapted to cause the bridge 106 to establish or to remove links between the communication channels.

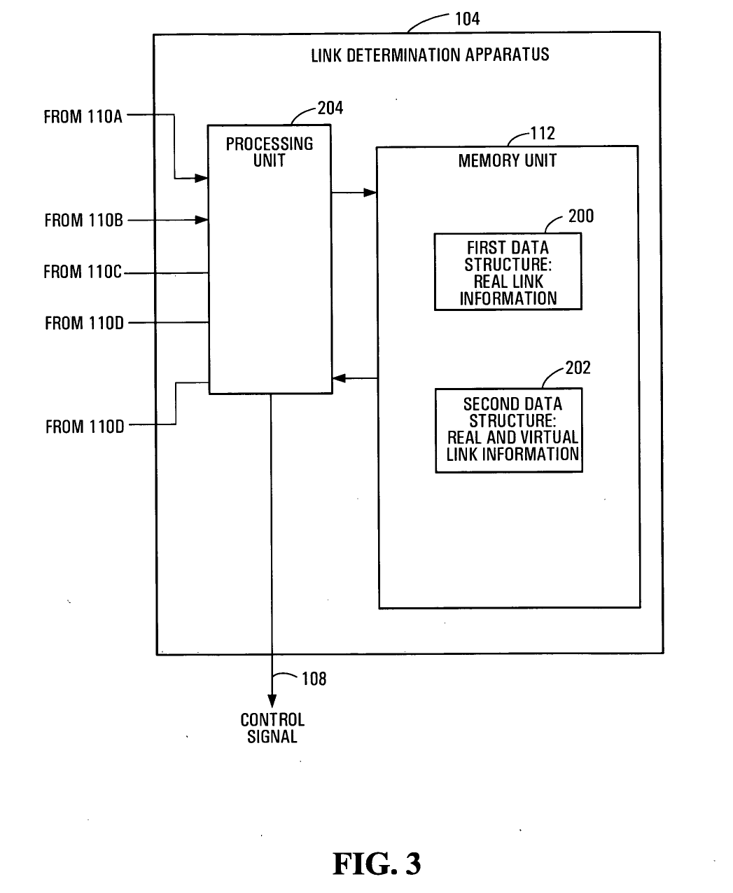

FIG. 3 shows a block diagram of a specific implementation of the link determination apparatus 104. As depicted, the link determination apparatus includes a memory unit 112 and a processing unit 204.

The memory unit 112 is suitable for storing real link information conveying a set of real links between communication channels in the set of communication channels. In a specific implementation, the real link information is derived on the basis of link request signals and exit signals received by the link determination apparatus 104 from the plurality of ports 102A-E. Link request signals request the creation of new real links and the exit signals request the removal of existing real links. The processing unit 204 is in communication with the memory unit 112 and processes the real link information to derive link control data conveying real link information and virtual link information. The processing unit 204 then derives and releases a control signal 108 at least in part on the basis of the link control data.

As depicted in FIG. 3, in a specific implementation, the memory unit 112 stores a first data structure 200 including a first set of data elements and a second data structure 202 including a second set of data element. The first data structure 200 conveys real link information between communication channels. The second data structure 202 conveys real link information and virtual link information.

In a specific implementation, the processing unit 204 processes the first data structure 200 conveying real link information between communication channels to derive the second data structure 202 conveying real and virtual link information between communication channels. The processing unit 204 further processes the second data structure 202 to derive link control data. The processing unit then derives and releases a control signal 108 at least in part on the basis of the link control data.

In a specific embodiment, the first data structure 200 and the second data structure 202 are square matrices. Each communication channel is associated to a respective row of the square matrices and to a respective column of the matrices. The association is such that a communication channel associated to a given row index is also associated to a same column index. Each entry of the matrix is associated to a potential link between two communication channels. In a non-limiting example of implementation, the entries of the matrix are either “1” or a “0” where a “1” indicates the presence of a link and a “0” indicates the absence of a link.

When the communication system 100 is first initialized, the first data structure 200 conveying real link information and the second data structure 202 conveying real link information and virtual link information are set to the unity matrix (diagonal entries “1” all other entries 0). New link requests or new exit requests are reflected in the first data structure 200 by modifying entries from “0” to “1” when a new real link is to be added or from “1” to “0” when a link is to be removed. The second data structure 202 is then derived by applying successive matrix squaring operations to the first data structure 200 and setting all non-zero entries to “1” between each squaring operation. The computation is complete when a squaring operation produces no change between the matrix prior to the squaring operation and the matrix after the squaring operation. The difference between the second matrix structure 202 and the first data structure 200 represents the virtual link information. It will be appreciated that since the second data structure 202 can be derived from the first data structure 200 there is no need to store the second data structure 202 in memory. However, certain implementations may choose to store the second data structure 202 without detracting from the spirit of the invention.

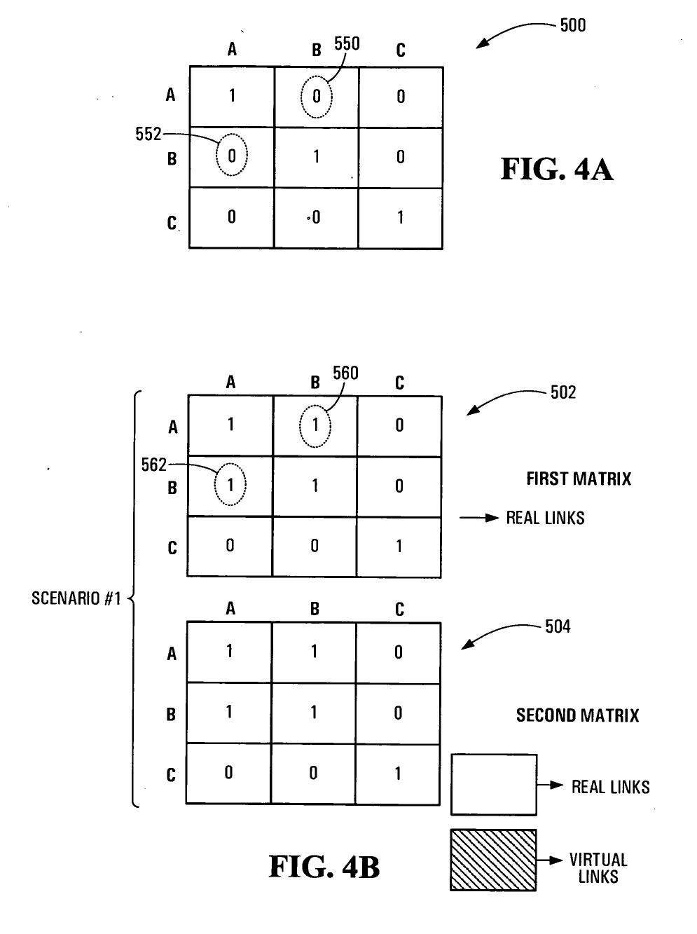

FIGS. 4a, 4b and 4c illustrate the use of square matrices to derive the virtual link information for three (3) communication channels A, B and C. More specifically, FIG. 4a of the drawings illustrates in graphical format a matrix data structure 500 for three (3) communication channels A, B and C. Each entry in the matrix 500, other than the entries in the diagonal, is associated to a unidirectional link between two communication channels. For example, entry 550 corresponds to a unidirectional link from communication channel A to communication channel B and entry 552 corresponds to a unidirectional link from communication channel B to communication channel A. In the matrix, a “1” indicates the presence of a link while a “0” indicates the absence of a link. Therefore, in order to convey a bi-directional link between communication channel B and communication channel A, both entries 550 and 552 would be set to “1”. It will be apparent that certain embodiments of the invention may invert the columns and the rows so that in such embodiments entry 550 would correspond to a unidirectional link from communication channel B to communication channel A and entry 552 would correspond to a unidirectional link from communication channel A to communication channel B.

As shown, the diagonal components of the square matrix 500 are set to “1” indicating that each communication channel is linked to itself. In other words, this is the situation where no communication link has been established. Initially both the first data structure 200 and the second data structure 202 have the same values.

FIG. 4b of the drawings illustrates in graphical format a first scenario where a request for a bi-directional link between communication channels A and B has been received. First matrix data structure 500 storing the real link information, is updated to set the entries 560 562 corresponding to the links between communication channels A and B to “1”. Second matrix data structure 504 is then derived by applying successive matrix squaring operations to the first data structure 500 and setting all non-zero entries to “1” between each squaring operation. In this first scenario, the first matrix data structure 502 and the second matrix data structure 504 have the same values indicating that no virtual links were created by the new request for a bi-directional link between communication channels A and B. The person skilled in the art will appreciate that this result is logical since by establishing a link between communication channels A and B, there are no other communication channels that should as a consequence be linked.

FIG. 4c of the drawings illustrates in graphical format a second scenario where a request for bi-directional link between communication channels A and C has been requested in addition to the bi-directional link between communication channels A and B requested in scenario 1 depicted in FIG. 4b. The first matrix data structure 502, storing the real link information, is updated to set the entries corresponding to the links 570 572 between communication channels A and C to “1”. All other entries remain the same. The second matrix data structure 504 is then derived by applying successive matrix squaring operations to the first data structure 502 and setting all non-zero entries to “1” between each squaring operation. In this second scenario, it can be observe that the second matrix data structure 504 includes two entries 580 582 which have been set to “1”. These two entries are virtual links that were created by the new request for a bi-directional link between communication channels A and C. With reference to FIG. 4c, the person skilled in the art will appreciate that entries 580 582 correspond to virtual links being established between communication channels B and C. It will also be appreciated that the second matrix data structure 504 includes all the entries associated to the real links in the first matrix data structure 502, as well as the virtual links.

As indicated above, FIGS. 4a, 4b and 4c illustrate the use of square matrices to derive the virtual link information for three (3) communication channels A, B and C. It will be appreciated that the above-described configuration may be applied to any number of communication channels without detracting from the spirit of the invention.

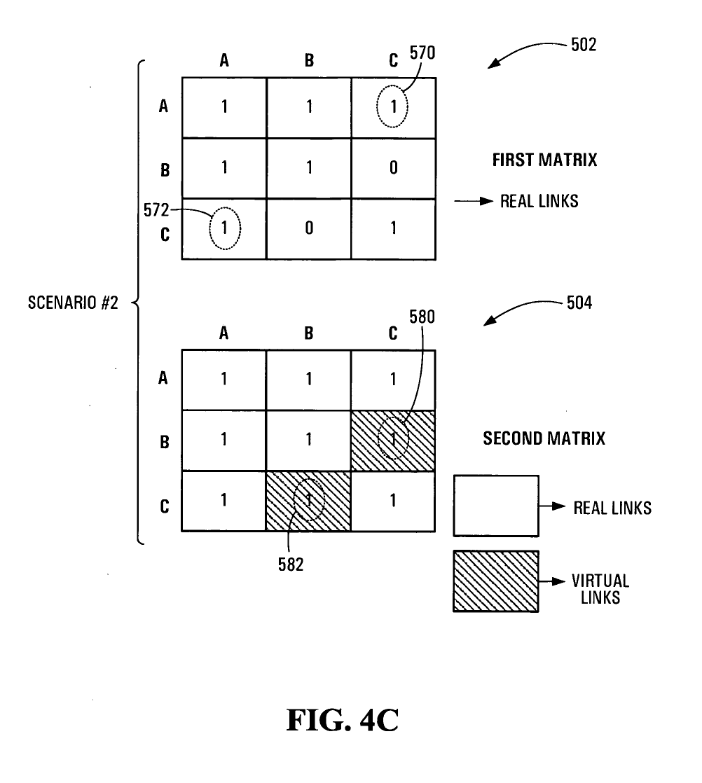

FIG. 5 of the drawings illustrates a process for deriving an updated second matrix data structure when either a new real link between two communication channels is requested or when an existing link between two communication channels is eliminated.

As shown, at step 700, in response to a link request signal or to an exit signal, the processing unit 204 updates the first matrix data structure. More specifically, in response to a link request signal, the processing unit 204 updates the first matrix data structure to set the entry (or entries in the case of a bi-directional link) corresponding to the new link(s) to “1”. In response to an exit request signal, the processing unit 204 updates the first matrix data structure to set the entry (or entries in the case of a bi-directional link) corresponding to the link(s) to be removed to “0”.

At step 701, an intermediate matrix is set to the first matrix. This intermediate matrix will be used to store the intermediate results of the computation.

At step 702, a reference matrix is set to the intermediate matrix. This reference matrix will be used to store values of the matrix during the computation.

At step 704, a squaring operation is applied to the intermediate matrix. Applying a squaring operation to a square matrix is well-known and any suitable scheme may be used here without detracting from the spirit of the invention.

At step 706, the non-zero entries in the intermediate matrix are set to “1”. The intermediate matrix now include “0” and “1” entries.

At step 708, the intermediate matrix is compared to the reference matrix to determine whether the squaring operation at step 704 resulted in a change in the entries of the intermediate matrix. If the comparison indicated that the entries of reference matrix and of the intermediate matrix are not the same, step 708 is answered in the negative and the process returns to step 702 where the reference matrix is set to the intermediate matrix and the squaring computation is re-iterated. If at step 708, the comparison indicated that the entries of the reference matrix and of the intermediate matrix were the same, step 708 is answered in the positive process proceeds to step 710 where the second matrix data structure is set to the intermediate matrix. The process then ends.

With reference to FIG. 3, the processing unit 204 then processes the second matrix to derive the control signal. In a non-limiting example, the control signal conveys that a link should be established between two communication links when a “1” is present in the corresponding entry in the matrix. Conversely, the control signal conveys that a link should be absent between two communication links when a “0” is present in the corresponding entry in the matrix.

It will be appreciated that the above-described configuration allows for new communication channels to be dynamically added or removed from the system 100. More specifically, when a new communication channel is added, the first data structure 200 and the second data structure 202 can each be augmented by a row and a column and the diagonal element is set to “1”. All other components can be derived as described above with a bigger matrix. In addition, when an existing communication channel is eliminated, the first data structure 200 is modified by removing the row and the column corresponding to the eliminated communication channel. It will be readily appreciated by the person skilled in the art that computation modules for processing matrices may be configured to be independent from the size of the matrix and as such, the size of the matrix may be provided as a parameter. As such, the above-described configuration is scalable to any number of communication channels provided that, when an additional communication is added, the system 100 includes sufficient numbers of ports 102A-E and that the bridge has the capacity to handle the additional communication channel.

Advantageously, uni-directional and bi-directional links are directly conveyed by the entries in the matrix. As such, the desired connectivity of communication channels associated to devices which can only transmit signal, only receive signal or transmit and receives signal is readily conveyed by the entries in the first and second matrix data structures.

Advantageously, communication system 100 can readily be used to manage multiple mutually independent conferences using the principles described above.

It will be appreciated that although the specific example of implementation described above makes use of matrices for deriving real and virtual link information, other methods for deriving virtual links on the basis of real links are possible. Such methods may include for example the use of relationship management algorithms to derive indirect relationships (virtual links) between a set of entities. As such, the above described implementation using matrices is a specific example of implementation of a method for deriving the virtual link information (indirect relationships) between the communication channels (set of entities). Other suitable methods may be implemented using recursive algorithms, imbedded if-then-else statements and other well-know programming techniques which will becomes apparent to the person skilled in the art in light of the present specification.

Interface Modules 110A-E

As described with reference to FIG. 1, in a specific implementation, the communication apparatus 100 optionally includes a plurality of interface modules 110A-E.

The interface modules 110A-E effect pre-processing functions on the signals received at the plurality of ports 102A-E such as to convert these signals into a format that can be processed by the link determination apparatus 104 and by the bridge 106. In a non-limiting example, the interface modules 110A-E process media information signals received at the ports 102A-E to derive media packets in a format that can be processed by the bridge 106 and releases these media packets to the bridge 106. The interface modules 110A-E also process control signals received at the ports 102A-E and derive link request signals (or link exit signal to remove an existing link) and releases these signals to the link determination apparatus 104. The interface modules 110A-E are also adapted for effecting post-processing functions on the signals received from the bridge 106 prior to forwarding these signals to the plurality of ports 102A-E. The purpose of such post-processing may be, for example, to convert the signals into a format that can be processed by the respective devices 128, 130, 132, 126 and 124 connected through ports 102A-E. Such pre-processing and post-processing functionality is particularly useful where devices of different types and operating in different communication domains are coupled to the plurality of ports 102A-E.

Non-limiting examples of pre-processing functionality that may be integrated into one or more interface modules 110A-E include:
Converting a signal from the circuit switched domain to the packet switched domain;
Converting an analog signal to a digital signal;
Processing speech signals to effect automatic speech recognition (ASR) or speaker verification;
Processing data signal to convert them into audio signals using text-to-speech technology prior to transmission to the bridge 106;
Any suitable codec for compressing/decompressing a signal, such as for example, MP3, “mu law”, etc.;

Non-limiting examples of post-processing functionality that may be integrated into one or more interface modules 110A-E include:
Converting a signal from the packet switched domain to the circuit switched domain;
Processing speech signals to effect automatic speech recognition (ASR) or speaker verification;
Tone detection;
Fax/Modem detection;
Echo cancellation.

In a specific implementation, the interface modules 110A-E are adapted to negotiate with the link determination apparatus 104 to request that a communication link be established or removed.

More specifically, take a first situation where a given device, say device A 128, wants to establish a link with another device, say device B, and device A 128 issues a signal to that effect through port 102A. In this first situation, the interface module 110A corresponding to device A 128 transmits a signal, say a DTMF tone, conveying a request for establishing a real link between device A 128 and device B 130 to the link determination apparatus 104. The request may specify whether the link is either bi-directional or uni-directional. Following this a negotiation protocol takes place between interface module 110A, interface module 110B and the link determination apparatus 104 so that the parameters of the conference are established. Such negotiation protocols are not critical to the invention and any suitable well-known protocol may be used here without detracting from the spirit of the invention. Conversely, take a second situation where device A 128, wants to cease communicating with device B and device A 128 issues a signal to that effect through port 102A. In this second situation, the interface module 110A corresponding to device A 128 transmits a signal conveying a request for removing a real link between device A 128 and device B 130 to the link determination apparatus 104.

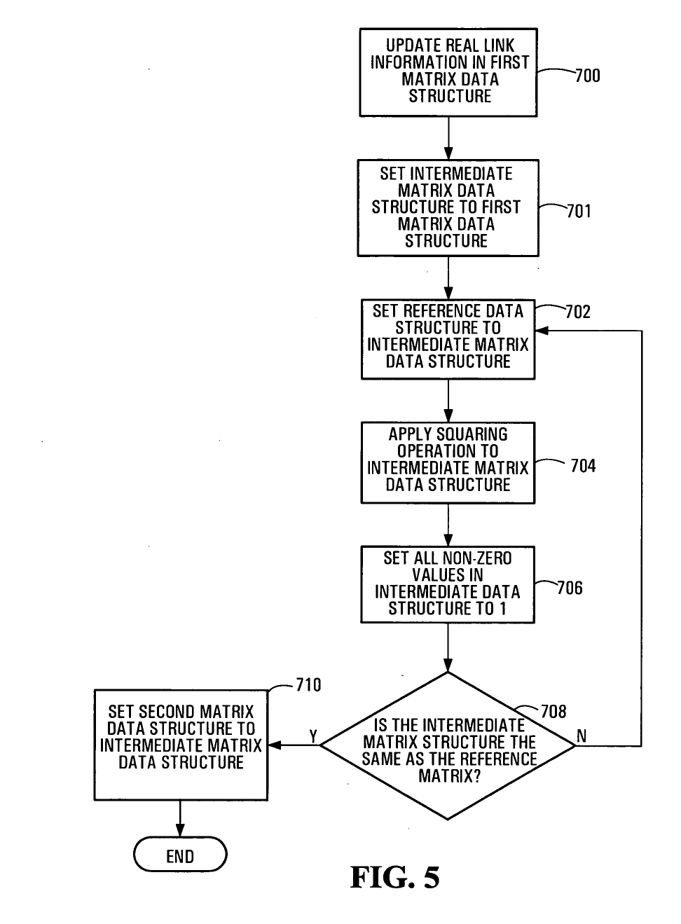

FIG. 6 shows in block diagram of interface modules 110A comprising a processing unit 1002 coupled to a first I/O 1016, a second I/O 1018, and a negotiation signal I/O 1020. The other interface modules 110B-E have a similar configuration and as such will not be described further here. The first I/O 1016 is used to exchange signals with port 102A. Such signals may be in any suitable format and may be indicative of speech, video or any other media signal suitable for use in a conference. In a non-limiting example, a commonly used signal format for speech is PCM. The second I/O 1018 is used to exchange data packets for exchange with the bridge 106. The negotiation signal I/O 1020 is for exchanging control signals with the link determination apparatus 104. It will be readily apparent that although the first I/O, the second I/O and the negotiation I/O are shown as unitary components in the drawings, they may also be embodied as separate component, such as an input and an output. The processing unit 1002 is adapted to implement the functionality described above.

It will be appreciated that, although the interface modules 110A-E have been depicted as components of the communication system 100, in certain embodiments, some or all the functionality of these modules 110A-E may be effected externally to the communication system 100, in a gateway for example, or may be integrated as part of the devices 128, 130, 132, 126 and 124 without detracting from the spirit of the invention.

Specific Physical Implementations

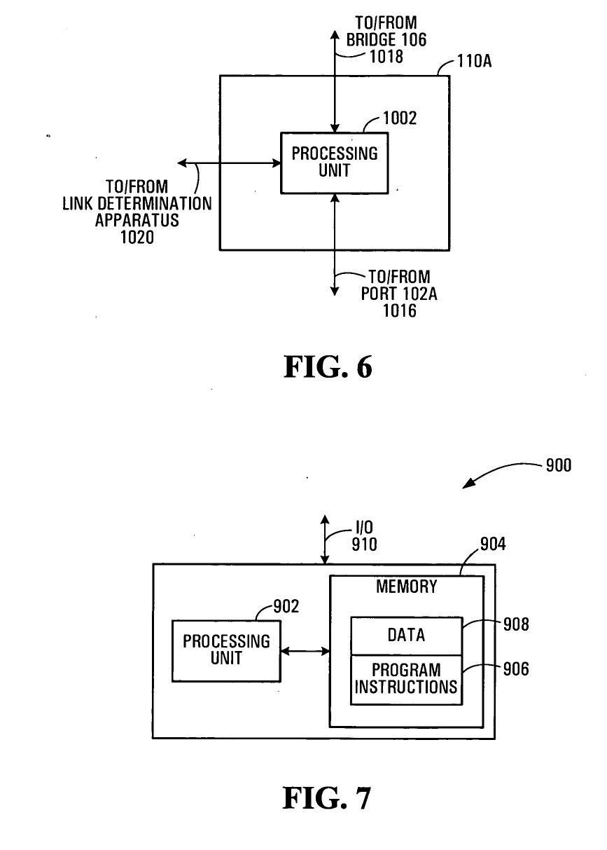

The above-described process for establishing links between communication channels can be implemented on a general purpose digital computer 900, of the type depicted in FIG. 7, including a processing unit 902 and a memory 904 connected by a communication bus 950. The memory includes data 908 and program instructions 906. The processing unit 902 is adapted to process the data 908 and the program instructions 906 in order to implement the functional blocks described in the specification and depicted in the drawings. The digital computer 900 may also comprise an I/O interface 910 for receiving or sending data elements to external devices. For example, the I/O interface 910 may be used for exchanging data with the ports 102A-E depicted in FIG. 1.

Alternatively, the above-described process for establishing links between communication channels can be implemented on a dedicated hardware platform where electrical/optical components implement the functional blocks described in the specification and depicted in the drawings. Specific implementations may be realized using ICs, ASICs, DSPs, FPGA or other suitable hardware platform. It will be readily appreciated that the hardware platform is not a limiting component of the invention. The hardware platform may be part of a commercial communication system or may be a personal user device.

In addition, although the communication system 100 has been depicted as a unitary component, the person skilled in the art will readily appreciate that the various modules of the communication system may be implemented by different physical modules without detracting from the spirit of the invention. In a non-limiting example of implementation, the interfaces 110A-E and the link determination apparatus 104 are implemented by a processing device and the bridge 106 is implemented by a general purpose digital computer in communication with the processing device implementing the link determination apparatus 104. In such a configuration, the processing device is a peripheral module of the general purpose digital computer and is adapted for receiving and processing link request information and/or link removal information to derive link control data.

In non-limiting examples of implementation, the communication system 100 suitable for establishing links between communication channels or the link determination apparatus 104 is embedded as part of either one of a PBX unit, a local area network LAN and a wide area network (WAN). In other non-limiting examples of implementation, the above-described process for establishing links between communication channels and the bridge is embedded as part of a VoIP telephone set, telephone set, personal computer board or any other suitable personal communication device.

Those skilled in the art will appreciate that various modifications and refinements can be made to the embodiments presented above without detracting from the scope of the present invention. The above description of the embodiments should not be interpreted in a limiting manner since other variations, modifications and refinements are possible within the spirit and scope of the present invention. The scope of the invention is defined in the appended claims and their equivalents.

1. A method for establishing links between communication channels, said method comprising:
a) providing real link information conveying a set of real links between communication channels in a set of communication channels;
b) processing said real link information to derive link control data conveying:
(1) the set of real links;
(2) virtual link information;
c) releasing a control signal for causing a communication apparatus to establish links between communications channels in the set of communication channels, the control signal being derived at least in part on the basis of said link control data.

2. A method as defined in claim 1, wherein said method comprises:
a) providing a first data structure including a first set of data elements, said first set of data elements conveying the set of real links between communication channels in the set of communication channels;
b) processing said first data structure to derive a second data structure including a second set of data elements, said second set of data elements conveying:
i) the set of real links;
ii) the virtual link information including at least one virtual link;
c) processing said second data structure to derive link control data.

3. A method as defined in claims 2, wherein said first data structure is a first matrix data structure and said second data structure is a second matrix data structure.

4. A method as defined in claim 3, wherein said first matrix data structure is a square matrix.

5. A method as defined in claim 4, wherein said second matrix data structure is a square matrix.

6. A method as defined in claim 5, wherein said method comprises applying a squaring operation to said first matrix data structure to derive said second matrix data structure.

7. A method as defined in claim 6, wherein said method comprises applying multiple squaring operation to said first matrix data structure to derive said second matrix data structure.

8. A method as defined in claim 1, said method further comprising:
a) in response to a signal indicative of a request for establishing a link between a first communication channel and a second communication channel in the set of communication channels:
i) modifying the real link information to derive new real link information, the new real link information conveying:
(1) the set of real links; and
(2) a new real link between the first communication channel and the second communication channel;
ii) processing the new real link information to derive new link control data;
iii) releasing a control signal derived at least in part on the basis of said new link control data.

9. A method as defined in claim 3, said method further comprising:
a) in response to a signal indicative of a request for establishing a link between a first communication channel and a second communication channel in the set of communication channels:
i) modifying the first matrix data structure to convey:
(1) the set of real links; and
(2) a new real link between the first communication channel and the second communication channel;
ii) updating said second matrix data structure on the basis of the first matrix data structure to derive an updated second matrix data structure;
iii) processing said second matrix data structure to derive new link control data;
iv) releasing a control signal derived at least in part on the basis of said new link control data.

10. A method as defined in claim 9, wherein at least one data elements of said updated second matrix data structure conveys a presence of a new virtual link between two communication channels in the set of communication channels.

11. A method as defined in claim 1, said method further comprising:
a) in response to a signal indicative of a request for removing a link between a first communication channel and a second communication channel in the set of communication channels:
i) modifying the real link information to derive new real link information, the new real link information conveying the absence of a link between the first communication channel and the second communication channel;
ii) processing the new real link information to derive new link control data;
iii) releasing a control signal derived at least in part on the basis of said new link control data.

12. A method as defined in claim 3, said method further comprising:
a) in response to a signal indicative of a request for removing a link between a first communication channel and a second communication channel in the set of communication channels:
i) modifying the first matrix data structure to convey absence of a link between the first communication channel and the second communication channel;
ii) updating said second matrix data structure on the basis of the first matrix data structure to derive an updated second matrix data structure;
iii) processing said second matrix data structure to derive new link control data;
iv) releasing a control signal derived at least in part on the basis of said new link control data.

13. A method as defined in claim 1, wherein the set of real links includes at least one real link indicative of a unidirectional link.

14. A method as defined in claim 1, wherein the set of real links includes at least one real link indicative of a bi-directional link.

15. An apparatus suitable for establishing links between communication channels, said apparatus comprising:
a) a memory unit for storing real link information conveying a set of real links between communication channels in a set of communication channels;
b) a processing unit in communication with said memory unit, said processing unit being operative for processing said real link information to derive link control data conveying:
(1) the set of real links;
(2) virtual link information;
c) an output for releasing a control signal for causing a communication apparatus to establish links between communications channels in the set of communication channels, the control signal being derived at least in part on the basis of said link control data.

16. An apparatus as defined in claim 15, wherein:
a) the real link information is stored in a first data structure including a first set of data elements, said first set of data elements conveying the set of real links between communication channels in the set of communication channels; and
b) said processing unit is operative for:
i) processing said first data structure to derive a second data structure including a second set of data elements, said second set of data elements conveying:
(1) the set of real links;
(2) the virtual link information including at least one virtual link;
ii) processing said second data structure to derive link control data.

17. An apparatus as defined in claims 16, wherein said first data structure is a first matrix data structure and said second data structure is a second matrix data structure.

18. An apparatus as defined in claim 17, wherein said first matrix data structure is a square matrix.

19. An apparatus as defined in claim 18, wherein said second matrix data structure is a square matrix.

20. An apparatus as defined in claim 19, wherein said processing unit is operative for applying a squaring operation to said first matrix data structure to derive said second matrix data structure.

21. An apparatus as defined in claim 20, wherein said processing unit is operative for applying multiple squaring operation to said first matrix data structure to derive said second matrix data structure.

22. An apparatus as defined in claim 15, wherein said processing unit is responsive to a signal indicative of a request for establishing a link between a first communication channel and a second communication channel in the set of communication channels for:
i) modifying the real link information to derive new real link information, the new real link information conveying:
(1) the set of real links; and
(2) a new real link between the first communication channel and the second communication channel;
ii) processing the new real link information to derive new link control data;
iii) causing the output to release a control signal derived at least in part on the basis of said new link control data.

23. An apparatus as defined in claim 17, wherein said processing unit is responsive to a signal indicative of a request for establishing a link between a first communication channel and a second communication channel in the set of communication channels for:
a) modifying the first matrix data structure to convey:
i) the set of real links; and
ii) a new real link between the first communication channel and the second communication channel;
b) updating said second matrix data structure on the basis of the first matrix data structure to derive an updated second matrix data structure;
c) processing said second matrix data structure to derive new link control data;
d) causing the output to release a control signal derived at least in part on the basis of said new link control data.

24. An apparatus as defined in claim 23, wherein at least one data elements of said updated second matrix data structure conveys a presence of a new virtual link between two communication channels in the set of communication channels.

25. An apparatus as defined in claim 15, wherein said processing unit is responsive to a signal indicative of a request for removing a link between a first communication channel and a second communication channel in the set of communication channels for:
a) modifying the real link information to derive new real link information, the new real link information conveying the absence of a link between the first communication channel and the second communication channel;
b) processing the new real link information to derive new link control data;
c) causing the output to release a control signal derived at least in part on the basis of said new link control data.

26. An apparatus as defined in claim 17, wherein said processing unit is responsive to a signal indicative of a request for removing a link between a first communication channel and a second communication channel in the set of communication channels for:
a) modifying the first matrix data structure to convey absence of a link between the first communication channel and the second communication channel;
b) updating said second matrix data structure on the basis of the first matrix data structure to derive an updated second matrix data structure;
c) processing said second matrix data structure to derive new link control data;
d) causing the output to release a control signal derived at least in part on the basis of said new link control data.

27. An apparatus as defined in claim 15, wherein the set of real links includes at least one real link indicative of a unidirectional link.

28. An apparatus as defined in claim 15, wherein the set of real links includes at least one real link indicative of a bi-directional link.

29. A communication system suitable for establishing links between communication channels, said system comprising:
a) a plurality of ports, each port being associated to a respective communication channel in a set of communication channels;
b) an apparatus in communication with the plurality of ports, said apparatus comprising:
i) a memory unit for storing real link information conveying a set of real links between communication channels in the set of communication channels;
ii) a processing unit in communication with said memory unit, said processing unit being operative for processing said real link information to derive link control data conveying:
(a) the set of real links;
(b) virtual link information;
iii) an output for releasing a control signal derived at least in part on the basis of said link control data;
c) a bridge in communication with said output, said bridge being responsive to the control signal for establishing links between the set of communication channels.

30. A communication system as defined in claim 29, wherein:
a) the real link information is stored in a first data structure including a first set of data elements, said first set of data elements conveying the set of real links between communication channels in the set of communication channels; and
b) said processing unit is operative for:
i) processing said first data structure to derive a second data structure including a second set of data elements, said second set of data elements conveying:
(1) the set of real links;
(2) the virtual link information including at least one virtual link;
ii) processing said second data structure to derive link control data.

31. A communication system as defined in claims 30, wherein said first data structure is a first matrix data structure and said second data structure is a second matrix data structure.

32. A communication system as defined in claim 31, wherein said first matrix data structure is a square matrix.

33. A communication system as defined in claim 32, wherein said second matrix data structure is a square matrix.

34. A communication system as defined in claim 33, wherein said processing unit is operative for applying a squaring operation to said first matrix data structure to derive said second matrix data structure.

35. A communication system as defined in claim 34, wherein said processing unit is operative for applying multiple squaring operation to said first matrix data structure to derive said second matrix data structure.

36. A communication system as defined in claim 29, wherein said processing unit is responsive to a signal indicative of a request for establishing a link between a first communication channel and a second communication channel in the set of communication channels for:
i) modifying the real link information to derive new real link information, the new real link information conveying:
(1) the set of real links; and
(2) a new real link between the first communication channel and the second communication channel;
ii) processing the new real link information to derive new link control data;
iii) causing the output to release a control signal derived at least in part on the basis of said new link control data.

37. A communication system as defined in claim 31, wherein said processing unit is responsive to a signal indicative of a request for establishing a link between a first communication channel and a second communication channel in the set of communication channels for:
a) modifying the first matrix data structure to convey:
i) the set of real links; and
ii) a new real link between the first communication channel and the second communication channel;
b) updating said second matrix data structure on the basis of the first matrix data structure to derive an updated second matrix data structure;
c) processing said second matrix data structure to derive new link control data;
d) causing the output to release a control signal derived at least in part on the basis of said new link control data.

38. A communication system as defined in claim 37, wherein at least one data elements of said updated second matrix data structure conveys a presence of a new virtual link between two communication channels in the set of communication channels.

39. A communication system as defined in claim 29, wherein said processing unit is responsive to a signal indicative of a request for removing a link between a first communication channel and a second communication channel in the set of communication channels for:
a) modifying the real link information to derive new real link information, the new real link information conveying the absence of a link between the first communication channel and the second communication channel;
b) processing the new real link information to derive new link control data;
c) causing the output to release a control signal derived at least in part on the basis of said new link control data.

40. A communication system as defined in claim 31, wherein said processing unit is responsive to a signal indicative of a request for removing a link between a first communication channel and a second communication channel in the set of communication channels for:
a) modifying the first matrix data structure to convey absence of a link between the first communication channel and the second communication channel;
b) updating said second matrix data structure on the basis of the first matrix data structure to derive an updated second matrix data structure;
c) processing said second matrix data structure to derive new link control data;
d) causing the output to release a control signal derived at least in part on the basis of said new link control data.

41. A communication system as defined in claim 29, wherein the set of real links includes at least one real link indicative of a unidirectional link.

42. A communication system as defined in claim 29, wherein the set of real links includes at least one real link indicative of a bi-directional link.

43. A communication system as defined in claim 29, wherein the bridge is implemented on a general purpose digital computer.

44. A computer readable storage medium including a program element suitable for execution by a computing apparatus for use in establishing links between communication channels, said computing apparatus comprising:
a) a memory unit for storing real link information conveying a set of real links between communication channels in a set of communication channels;
a) a processor operatively connected to said memory unit, said program element when executing on said processor being operative for:
i) processing said real link information to derive link control data conveying:
(1) the set of real links;
(2) virtual link information;
ii) releasing a control signal for causing a communication apparatus to establish links between communications channels in the set of communication channels, the control signal being derived at least in part on the basis of said link control data.

45. A computer readable storage medium as defined in claim 44, wherein:
a) the real link information is stored in a first data structure including a first set of data elements; and
b) said program element when executing on said processor being operative for:
i) processing said first data structure to derive a second data structure including a second set of data elements, said second set of data elements conveying:
(1) the set of real links;
(2) the virtual link information including at least one virtual link;
ii) processing said second data structure to derive link control data.

46. A computer readable storage medium as defined in claims 45, wherein said first data structure is a first matrix data structure and said second data structure is a second matrix data structure.

47. A computer readable storage medium as defined in claim 46, wherein said first matrix data structure is a square matrix.

48. A computer readable storage medium as defined in claim 47, wherein said second matrix data structure is a square matrix.

49. A computer readable storage medium as defined in claim 48, wherein said program element when executing on said processor is operative for applying a squaring operation to said first matrix data structure to derive said second matrix data structure.

50. A computer readable storage medium as defined in claim 49, wherein said program element when executing on said processor is operative for applying multiple squaring operation to said first matrix data structure to derive said second matrix data structure.

51. A computer readable storage medium as defined in claim 44, wherein said program element when executing on said processor is responsive to a signal indicative of a request for establishing a link between a first communication channel and a second communication channel in the set of communication channels for:
i) modifying the real link information to derive new real link information, the new real link information conveying:
(1) the set of real links; and
(2) a new real link between the first communication channel and the second communication channel;
ii) processing the new real link information to derive new link control data;
iii) releasing a control signal derived at least in part on the basis of said new link control data.

52. A computer readable storage medium as defined in claim 46, wherein said program element when executing on said processor is responsive to a signal indicative of a request for establishing a link between a first communication channel and a second communication channel in the set of communication channels for:
a) modifying the first matrix data structure to convey:
i) the set of real links; and
ii) a new real link between the first communication channel and the second communication channel;
b) updating said second matrix data structure on the basis of the first matrix data structure to derive an updated second matrix data structure;
c) processing said second matrix data structure to derive new link control data;
d) releasing a control signal derived at least in part on the basis of said new link control data.

53. A computer readable storage medium as defined in claim 52, wherein at least one data elements of said updated second matrix data structure conveys a presence of a new virtual link between two communication channels in the set of communication channels.

54. A computer readable storage medium as defined in claim 15, wherein said processing unit is responsive to a signal indicative of a request for removing a link between a first communication channel and a second communication channel in the set of communication channels for:
a) modifying the real link information to derive new real link information, the new real link information conveying the absence of a link between the first communication channel and the second communication channel;
b) processing the new real link information to derive new link control data;
c) causing the output to release a control signal derived at least in part on the basis of said new link control data.

55. A computer readable storage medium as defined in claim 44, wherein said program element when executing on said processor is responsive to a signal indicative of a request for removing a link between a first communication channel and a second communication channel in the set of communication channels for:
a) modifying the first matrix data structure to convey absence of a link between the first communication channel and the second communication channel;
b) updating said second matrix data structure on the basis of the first matrix data structure to derive an updated second matrix data structure;
c) processing said second matrix data structure to derive new link control data;
d) releasing a control signal derived at least in part on the basis of said new link control data.

56. A computer readable storage medium as defined in claim 55, wherein the set of real links includes at least one real link indicative of a unidirectional link.

57. A computer readable storage medium as defined in claim 44, wherein the set of real links includes at least one real link indicative of a bi-directional link.

58. An apparatus suitable for establishing links between communication channels, said apparatus comprising:
a) means for storing real link information conveying a set of real links between communication channels in a set of communication channels;
b) processing means for processing said real link information to derive link control data conveying:
(1) the set of real links;
(2) virtual link information;
c) means for releasing a control signal for causing a communication apparatus to establish links between communications channels in the set of communication channels, the control signal being derived at least in part on the basis of said link control data.
